(19) United States
(12) Patent Application Publication
(10) Pub. No.: US 2025/0329833 A1
(43) Pub. Date: Oct. 23, 2025

(54) BATTERY COVER SYSTEM

(71) Applicant: GMI Holdings, Inc., Mt. Hope, OH (US)

(72) Inventors: Michael R. Noyes, Fairfield, OH (US); Daniel Punchak, Wadsworth, OH (US); Erik J. Rose, Longview, TX (US)

(21) Appl. No.: 18/637,803

(22) Filed: Apr. 17, 2024

(51) Int. Cl. H01M 50/202; H01M 50/244; H01M 50/247; H01M 50/262; H01M 50/545; H01M 50/56

(52) U.S. Cl. CPC H01M 50/202; H01M 50/244; H01M 50/247; H01M 50/262; H01M 50/545; H01M 50/56

(57) ABSTRACT

A battery cover system for a portable device including. a printed circuit board (PCB) located in the portable device; a terminal mounted on the PCB configured to cover a portion of a battery when the battery is located in the terminal; and a cover configured to attach to the terminal and to cover at least a portion of the battery not covered by the terminal when the battery is located in the terminal, the terminal and cover together secure the battery in place in the terminal, wherein the cover is electrically connected to one of the positive and negative portions of the battery when the battery is located in the terminal and the other of the positive and negative portions of the battery not contacting the cover is contacting an electrical contact attached to the PCB.

### TECHNICAL FIELD

The present disclosure relates generally to battery securing and protection systems, and more particularly, to a battery securing and protection system for portable battery operated devices that use coin shaped batteries.

### BACKGROUND

Disk shaped batteries, sometimes referred to as coin shaped or simply coin batteries have long been used in remote devices such as remote controls, cameras, scopes, transmitters and various other devices where small and powerful batteries are desired. As such, it is useful to have a system to secure the battery in place in the device and protect the battery.

Recently, new laws, rules, regulations and/or standards have come into being requiring that such coin shaped batteries be made less accessible to children. Some of these requirements may demand that devices that use coin batteries become more difficult for children to access the batteries and/or remove the batteries from the devices. It may also be desirable to make these devices so that it is more difficult to contact the battery, and particularly the positive or negative sides of a battery with body parts (such as fingers, tongue, etc.) when the battery is installed in a portable device.

### SUMMARY

The foregoing needs are met to a great extent by embodiments in accordance with the present disclosure, wherein, a system or method for making it more difficult for children to access and/or remove the batteries from the devices, and making it more difficult to contact the battery with body parts (such as fingers, tongue, etc.) when the battery is installed in a portable device.

In one aspect, the disclosure describes a battery cover system for a portable device including: a terminal configured to cover a portion of a battery when a battery is located in the terminal; and a cover configured to attach to the terminal and to cover at least a portion of the battery not covered by the terminal when the battery is located in the terminal, the terminal and cover together secure the battery in place in the terminal, wherein the cover is electrically connected to one of the positive and negative portions of the battery when the battery is located in the terminal.

In another aspect, the disclosure describes a battery cover for a portable device. The battery cover system includes a printed circuit board (PCB) located in the portable device; a terminal mounted on the PCB configured to cover a portion of a battery when a battery is located in the terminal; and a cover configured to attach to the terminal and to cover at least a portion of the battery not covered by the terminal when the battery is located in the terminal, the terminal and cover together secure the battery in place in the terminal, wherein the cover is electrically connected to one of the positive and negative portions of the battery when the battery is located in the terminal and the other of the positive and negative portions of the battery not contacting the cover is contacting an electrical contact attached to the PCB.

In yet another aspect, the disclosure describes a method of protecting a battery. The method includes: mounting a terminal on a PCB; configuring the terminal to cover a portion of a battery when the battery is located in the terminal; attaching a cover to the terminal and to cover at least a portion of the battery not covered by the terminal when the battery is located in the terminal; securing the battery in place with the terminal and cover together; electrically connecting the cover to one of the positive and negative portions of the battery when the battery is located in the terminal; and connecting the other of the positive and negative portions of the battery not contacting the cover to an electrical contact attached to the PCB.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Additional features, advantages, and aspects of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate aspects of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 is an exploded, perspective view of a battery cover system with a battery installed in the system.

FIG. 2 is an exploded, perspective view of a battery cover system with a battery installed in the system taken from a different angle.

FIG. 3 is an exploded, perspective view of a battery cover system with a battery installed in the system taken from a different angle.

FIG. 4 is an exploded, perspective view of a battery cover system with a battery installed in the system taken from a different angle.

FIG. 5 is an exploded, top view of a battery cover system with a battery installed.

FIG. 6 is a cross-sectional view taken along line 6-6 of FIG. 5.

FIG. 7 is an exploded, perspective view of a battery cover system with a battery not installed, but shown exploded with other portions of the system.

FIG. 8 is an exploded, perspective view of a battery cover system with a battery not installed but shown exploded with other portions of the system taken from a different angle.

FIG. 9 is an exploded, perspective view of a battery cover system with a battery not installed but shown exploded with other portions of the system taken from a different angle.

FIG. 10 is an exploded, perspective view of a battery cover system with a battery not installed but shown exploded with other portions of the system taken from a different angle.

FIG. 11 is an assembled, perspective view of a battery cover system with a battery installed.

FIG. 12 is an assembled, perspective view of a battery cover system with a battery installed taken from a different angle.

FIG. 13 is an assembled, perspective view of a battery cover system with a battery installed taken from a different angle.

FIG. 14 is an assembled, perspective view of a battery cover system with a battery installed taken from a different angle.

FIG. 15 is an assembled, top view of a battery cover system with a battery installed.

FIG. 16 is a cross-sectional view taken along line 16-16 of FIG. 15.

FIG. 17 is an assembled, side view of a battery cover system with a battery installed.

FIG. 18 is an assembled, end view of a battery cover system with a battery installed.

### DETAILED DESCRIPTION

The aspects of the disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted to not unnecessarily obscure the aspects of the disclosure. The examples used herein are intended merely to facilitate an understanding of ways in which the disclosure may be practiced and to further enable those of skill in the art to practice the aspects of the disclosure. Accordingly, the examples and aspects herein should not be construed as limiting the scope of the disclosure, which is defined solely by the appended claims and applicable law. Moreover, it is noted that like reference numerals represent similar parts throughout the several views of the drawings.

It will be understood that certain sentence constructions found herein may describe a combination to include “one of [feature A] and [feature B]” or a like construction. Such a sentence combination should be understood that the combination may include only feature A (and not feature B) or only include feature B (and not feature A), or there could be both feature A and B in the combination. However, the combination does not necessarily require inclusion of both features A and B.

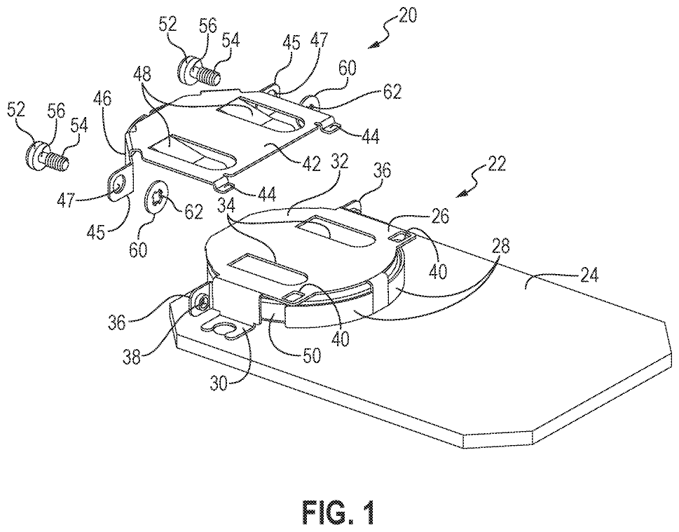

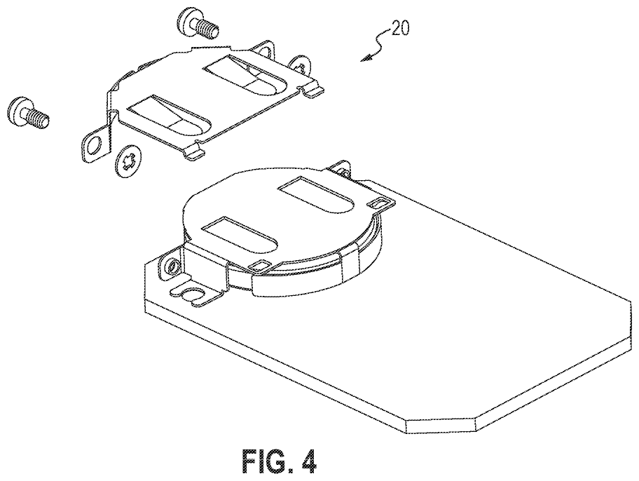

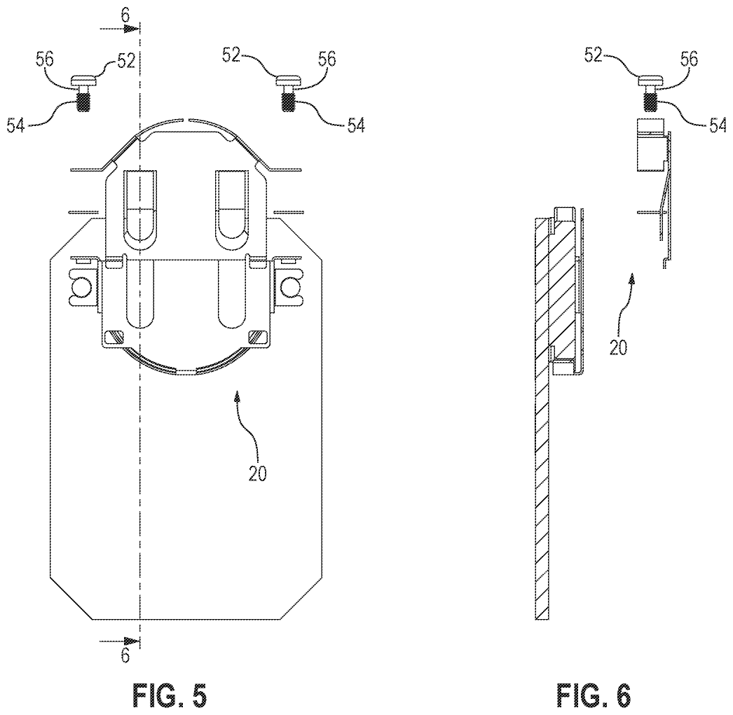

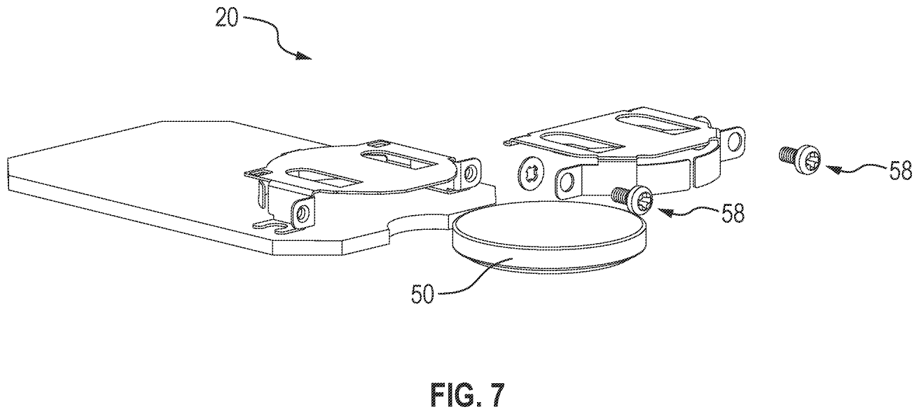

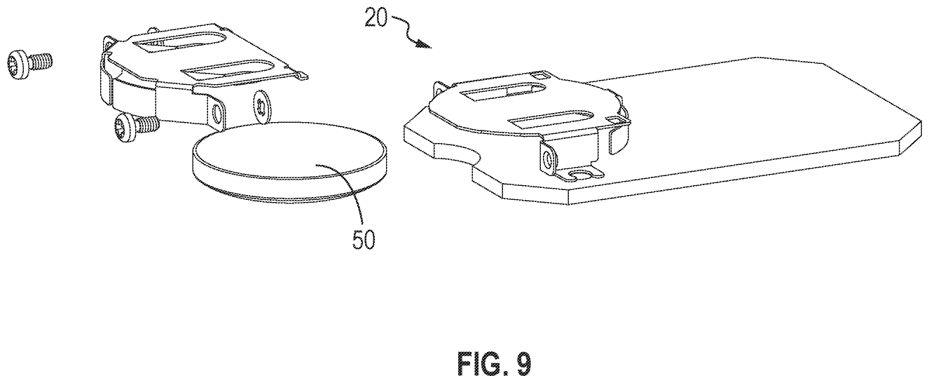

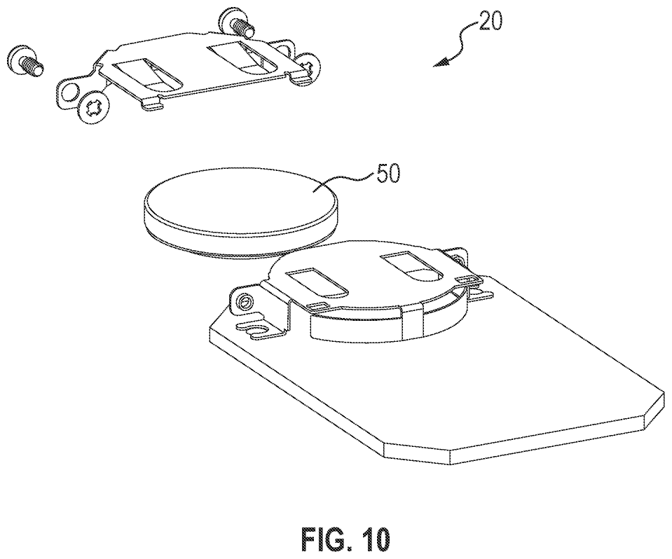

FIGS. 1-10 are various exploded views of a battery shielding system 20 for a remote powered device 22 in accordance with the present disclosure. In FIGS. 1-6, a battery 50 is shown installed in the battery shielding system 20. FIG. 6 is a cross-sectional view taken along the line 6-6 of FIG. 5. In FIGS. 7-10, The battery 50 is not installed in the battery shielding system 20 but shown in an exploded view with other parts also shown in an exploded configuration.

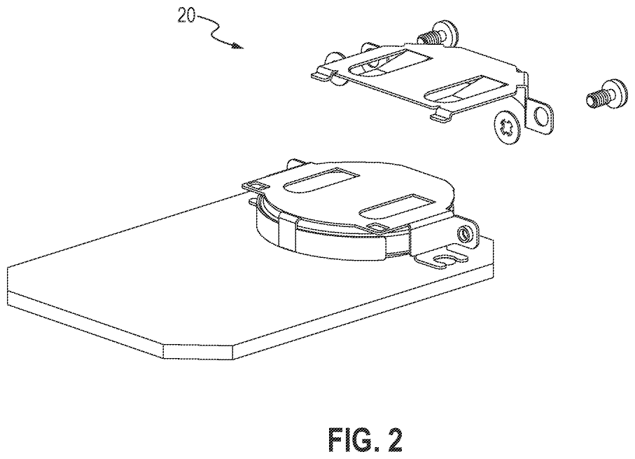

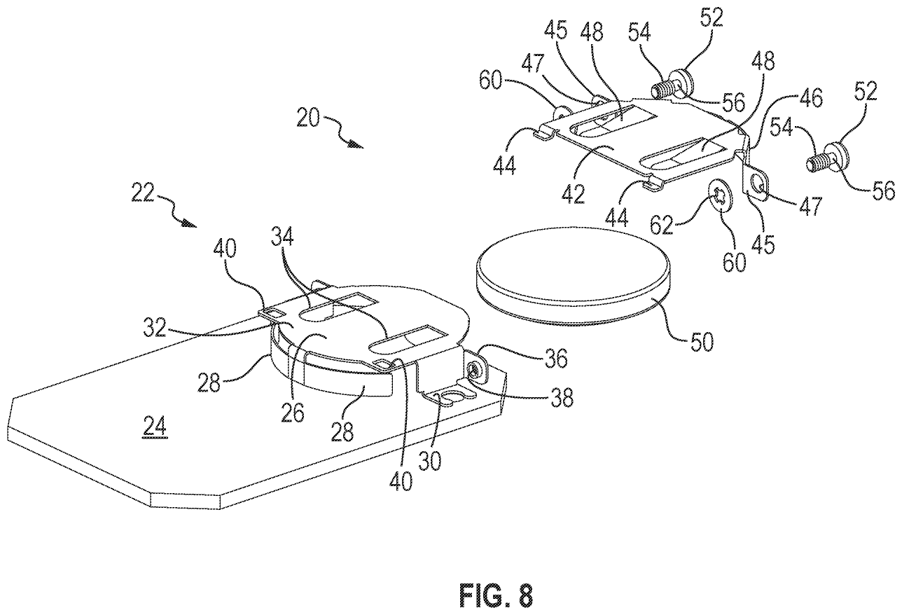

Most of the reference characters for FIGS. 1-6 are labeled on FIG. 1 and for FIGS. 7-10, most of the reference characters are labeled in FIG. 8, but other than a few characters mentioned in specific FIGS., many reference characters are omitted in FIGS. 2-7, 9-10 in order to avoid overcrowding the FIGS. It will be appreciated by one of ordinary skill in the art, after reviewing this disclosure, that many parts labeled with reference characters in one FIG., are also present in other FIGS., and in many instances, are shown in different views but are not labeled with reference characters to more clearly show a battery shielding system 20 without overcrowding the FIGS.

As shown in FIGS. 1-10 and labeled primarily in FIGS. 1 and 8, A battery shielding system 20 is located on a remote device 22. Non-limiting examples of remote devices 22 which may incorporate the battery shielding system 20 may include remote controls, transmitters, cameras, calculators, light sources, handheld electronics, optical devices, or any other device that may use a coin type battery. Specific features for specific remote devices 22 which may incorporate the battery shielding system 20 are outside the scope of this disclosure and are not shown or discussed in detail.

In accordance with the present disclosure, the battery shielding system 20 may be mounted on a printed circuit board (PCB) 24. The PCB 24 may also serve as a substrate for other electronic components (not shown) particular to a type of remote device 22 incorporating the battery shielding system 20.

The battery shielding system 20 may perform several functions. For example, the battery shielding system 20 may shield, or help shield a battery 50 from contact from undesirable objects, such as human body parts, (e.g. a child's fingers, tongue), foreign objects that could contact the battery 50 and could compromise the battery 50 and/or conductive objects that could compromise the battery 50. Further, the battery shielding system 20 may help retain the battery 50 in place and electrically and operatively connect the battery 50 circuits associated with the PCB 24. Finally, the battery shielding system 20 may make access to the battery 50, more child resistant. The child resistance features of the battery shielding system 20, may be desirable as allowing children access to batteries 50 whether simply touching the battery 50 or having access to be able to remove the battery 50 from a device 22 may be undesirable.

As shown in FIGS. 1-10 and indicated in FIGS. 1 and 8, the battery shielding system 20 includes a battery terminal plate 26 (sometimes referred to herein as a terminal 26). The terminal 26 may have terminal shielding 28 that extends over the outer edges of the battery 50. In some embodiments, the terminal shielding 28 may be in the form of flanges that extend around the battery 50 and may both shield the battery 50 and keep it in place.

The terminal 26 may also include terminal leads 30 that extend from the terminal top portion 32 to the PCB 24 and allow that terminal 26 to attached to the PCB 24. In some embodiments, the terminal leads 30 may be soldered to the PCB 24, attached by fasteners, or otherwise attached to the PCB 24. As shown in the FIGS., some embodiments may have terminal holes 34 located in the terminal top portion 32 for reasons that will be discussed later below. The terminal 26 includes fastener flanges 36 equipped with fastener holes 40. The terminal top portion 32 may also have attaching holes 40.

The battery shielding system 20 includes a battery cover 42 that attaches to and interacts with the battery terminal 26 to shield the battery 50, keep it in place, and cover the battery 50. The cover 42 has attaching hooks 44 that fit into the attaching holes 40 located on the terminal 26. The interface formed with the attaching hooks 44 slid into the attaching holes 40 secures one end of the cover 42 to the terminal 26. The other end of the cover 42 has attaching flanges 45 and battery protection flanges 46 for covering, at least in part, the battery 50. The cover 42, in some embodiments, has spring arms 48.

The attaching flanges 45 have cover attaching holes 47 that are located and dimensioned to align with the terminal fastener holes 38 to allow a fastener 52 to enter the holes 38 and 47 to attach the cover 42 to the terminal 26. In some embodiments, the one or more of the fastener holes 38 and 47 may be threaded to interact with threads 54 on the fasteners 52 to attach the terminal 26 and the cover 42. In other embodiments, the holes 38 and 47 may be not threaded, and a nut (not shown) is used to interact with the threads 54 on the fasteners 52 to secure the cover 42 to the terminal 26.

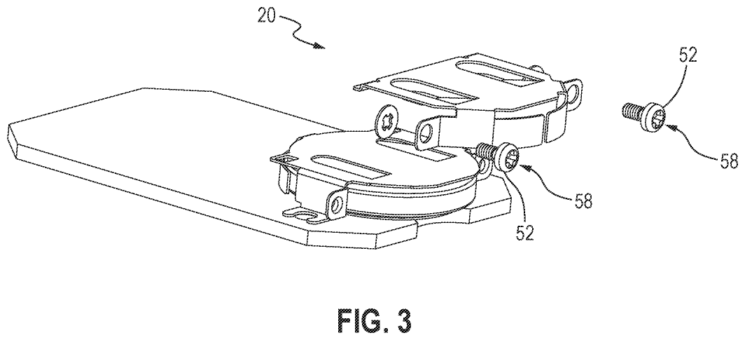

The fasteners 52 may include turning structure to allow the fasteners 52 to be turned. As shown in FIGS. 3 and 7, the turning structure are cross grooves 58 compatible with being turned by a Phillips head screwdriver. In other embodiments, the turning structure may be a single groove for use with a standard head screwdriver, an Allen or Torx hole configured to be turned with Allen or Torx wrenches. Still other fasteners 52 could be equipped with hex heads for turning with wrenches or any other suitable turning structure.

In some embodiments, it may be desirable to retain the fasteners 52 so that the fasteners 52 do not become misplaced or lost. In other words, cause the fasteners 52 to be captured screws. In such embodiments, retaining washers 60 having fastener receiving holes 62 may be used. The retaining washers 60 may be made of a resilient material such as plastic or rubber. As shown in FIGS. 5-6 the fasteners 52 have a shoulder 56 located above the threads 54. The retaining washers 60 and cover attaching flanges 45 may reside on the shoulder 56. In this manner, the fasteners 52 may be turned to attach or loosen the cover 42 from the terminal 26 while keeping the fasteners attached to the cover 42 without becoming misplaced or lost.

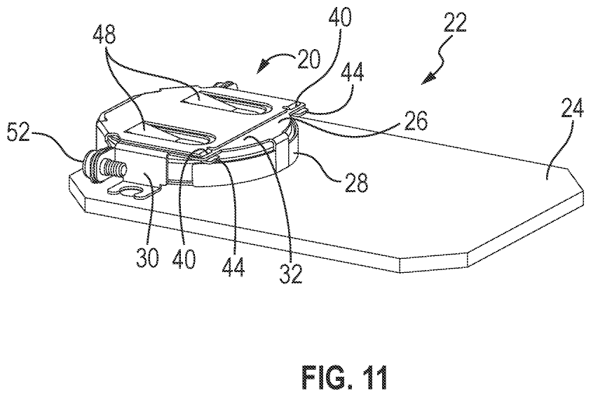

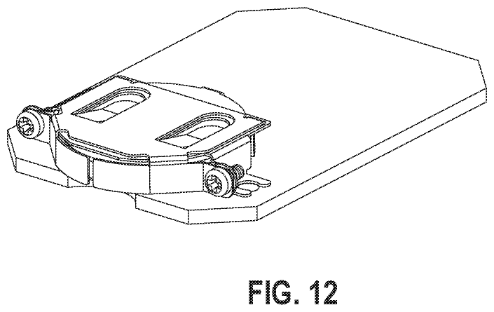

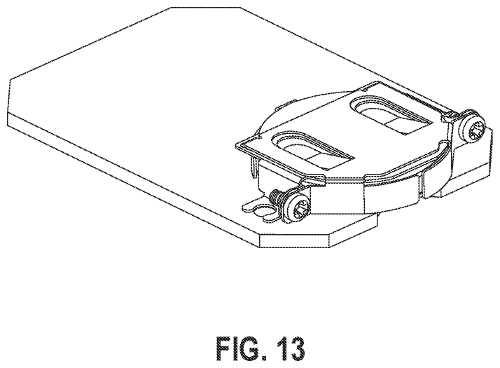

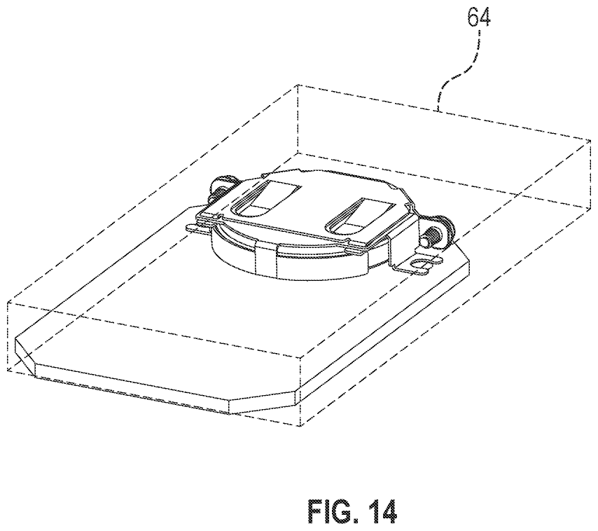

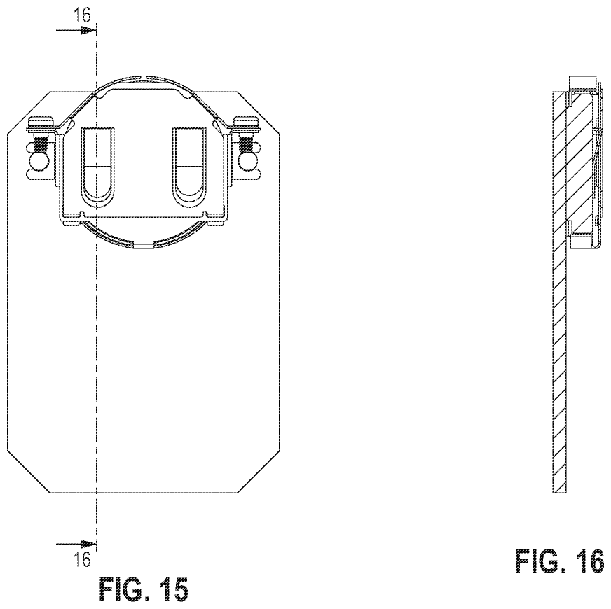

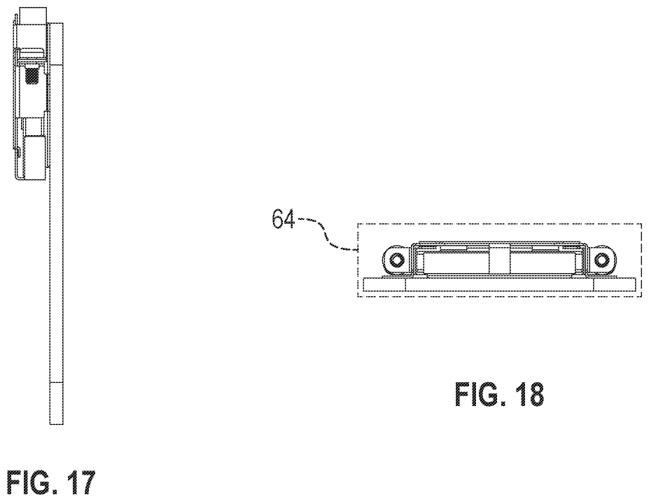

FIGS. 11-18 show an assembled view of the battery shielding system 20 taken from various views. FIG. 16 is a cross sectional view taken along the lines 16-16 on FIG. 15. FIG. 15 is a top view, FIG. 17 is a side view and FIG. 18 is an end view. FIGS. 14 and 18 also show an example housing 64 in broken lines for a battery powered device 22 in which the battery shielding system 20 and PCB 24 may reside.

FIG. 11 shows the battery shielding system 20 for a battery powered device 22 having a PCB 24. The battery terminal 26 is shown having terminal shielding 28, and terminal leads 30. The spring arms 48 extend through the terminal top portion 32 and contact the battery 50 as in the other FIGS. shown and described elsewhere herein. The fasteners 52 are shown attaching the cover 42 to the terminal 26. In addition, cover attaching hooks 44 are shown in the terminal attaching holes 40 to help secure the cover 42 to the terminal 26.

None of the FIGS. herein are intended to be inconsistent with each other, but rather show exploded views, both with the battery 50 installed on the PCB 24 and moved away from being installed on the PCB 24 for better illustration, as well as assembled views. As mentioned above, in order to better show features of the drawings, reference characters have been omitted from many views to avoid overcrowding the drawings. It will be understood that absence of a reference character from a particular view or views should not be interpreted to mean the featured associated with that reference character is not shown in that view or views.

Typically coin batteries 50 have the positive and negative portions, and the positive and negative portions of the battery 50 are located on the top and bottom of the battery 50. The sides of the battery 50 not typically electrically charged. As mentioned above, the spring arms 48 located on the cover 42 extend through holes terminal holes 34 and contact the battery 50. The contact with the spring arms 48 with the battery 50 provides a mechanical (because the spring arms 48 flex when contacting the battery 50 as the cover 42 is set into place and secured on to the terminal 26) and an electrical connection with either the positive or negative side of the battery 50 (depending upon whether the coin battery 50 is placed right side up or upside down in the terminal 26). The cover 42 may be made of a conductive material, such as metal (for example, copper, steel, stainless steel) or other conductive material. The cover 42 may act as a conduit to operably connect the battery 50 to a circuit (not shown) on the PCB 24 via the cover attaching flanges 45 to the terminal leads 30 via contact and/or fasteners 52.

In alternative embodiments, the cover 42 may be made of a non-conductive material (such as plastic or other suitable material) and have electrical leads located on or embedded in the cover 42 and spring arms 48 that contact the battery 50 and operatively connect the battery 50 to a circuit associated with the PCB 24 when the spring arms 48 contact the battery 50.

The other of the positive and negative side of the battery 50 not contacting the spring arms 48 may directly contact the PCB 24 or a circuit leads (not shown) located on the PCB 24 to power the circuitry located on the PCB 24 and ultimately the remote device 22.

The configuration of using the spring arms 48 to electrically connect to the top of the battery 50 rather than the terminal 26 electrically connecting to the top of the battery 50 promotes the concept that the cover 42 be in place in order for the battery 50 to power the device 22. This ensures that battery 50 is protected and secured in place before the device 22 can be powered.

While the disclosure has been described in terms of exemplary aspects, those skilled in the art will recognize that the disclosure can be practiced with modifications in the spirit and scope of the appended claims. These examples given above are merely illustrative and are not meant to be an exhaustive list of all possible designs, aspects, applications or modifications of the disclosure.

We claim:

1. A battery cover system for a portable device comprising:
a terminal configured to cover a portion of a battery when the battery is located in the terminal; and
a cover configured to attach to the terminal and to cover at least a portion of the battery not covered by the terminal when the battery is located in the terminal, the terminal and cover together secure the battery in place in the terminal,
wherein the cover is electrically connected to one of the positive and negative portions of the battery when the battery is located in the terminal.

2. The battery cover system for the portable device of claim 1, further comprising terminal leads located on the terminal and configured to attach to a printed circuit board.

3. The battery cover system for the portable device of claim 2, wherein the terminal is configured to allow the other of the positive and negative sections of the battery than the positive or negative section connected to the cover to be operatively connected to the printed circuit board.

4. The battery cover system for the portable device of claim 1, further comprising slots in the terminal and spring arms attached to the cover extending through the slots to contact the battery when the battery is located in the terminal.

5. The battery cover system for the portable device of claim 4, wherein the spring arms are resilient and configured to exert a force on the battery when the battery is located in the terminal.

6. The battery cover system for the portable device of claim 1, further comprising connecting fasteners connecting the cover to the terminal.

7. The battery cover system for the portable device of claim 6, wherein the fasteners are screws.

8. The battery cover system for the portable device of claim 7, further comprising a shoulder located between a threaded portion of the screw and a head of the screw.

9. The battery cover system for the portable device of claim 6, wherein the fasteners are captured to remain attached to one of either the cover or the terminal while allowing the cover to be attached to and detached from the terminal.

10. The battery cover system for the portable device of claim 9, further comprising resilient washers located on the fasteners and providing the capturing of the fasteners.

11. The battery cover system for the portable device of claim 1 wherein the terminal and the cover are dimensioned and configured to cover a coin shaped battery.

12. The battery cover system for the portable device of claim 11, further comprising protection flanges located on the cover and the terminal, the flanges configured to cover a perimeter of the coin shaped battery.

13. The battery cover system for the portable device of claim 1, further comprising cover attaching structure configured to attach to corresponding attaching structure located on the terminal.

14. The battery cover system for the portable device of claim 1, wherein the terminal is configured to allow the battery to contact a printed circuit board and the cover is electrically connected to a circuit located on the printed circuit board.

15. A battery cover system for a portable device comprising:
a printed circuit board (PCB) located in the portable device;
a terminal mounted on the PCB configured to cover a portion of a battery when the battery is located in the terminal; and
a cover configured to attach to the terminal and to cover at least a portion of the battery not covered by the terminal when the battery is located in the terminal, the terminal and cover together secure the battery in place in the terminal,
wherein the cover is electrically connected to one of the positive and negative portions of the battery when the battery is located in the terminal and the other of the positive and negative portions of the battery not contacting the cover is contacting an electrical contact attached to the PCB.

16. The battery cover system for the portable device of claim 15, further comprising slots in the terminal and spring arms attached to the cover extending through the slots to contact the battery when the battery is located in the terminal, wherein the spring arms are resilient and configured to exert a force on the battery when the battery is located in the terminal.

17. The battery cover system of claim 15, further comprising fasteners removably attaching the cover to the terminal, wherein the fasteners are captured to remain attached to one of either the terminal or the cover while allowing the cover to be attached to, and detached from, the terminal.

18. A method of protecting a battery comprising:
mounting a terminal on a PCB;
configuring the terminal to cover a portion of a battery when the battery is located in the terminal;
attaching a cover to the terminal and to cover at least a portion of the battery not covered by the terminal when the battery is located in the terminal;
securing the battery in place with the terminal and cover together;
electrically connecting the cover to one of the positive and negative portions of the battery when the battery is located in the terminal; and
connecting the other of the positive and negative portions of the battery not contacting the cover to an electrical contact attached to the PCB.

19. The method of claim 18, further comprising extending spring arms on the cover through slots in the terminal to contact the battery.

20. The method of claim 18, connecting the cover to the terminal with captured fasteners so that the cover can be attached to, and removed from, the terminal while the fasteners remain connected to at least one of either the cover and terminal.
